(19) United States
(12) Patent Application Publication
(10) Pub. No.: US 2011/0207001 A1
(43) Pub. Date: Aug. 25, 2011

(54) RECHARGEABLE ZINC-AIR BATTERY

(76) Inventors: Paolo Bert, Como (IT); Marina Ragnoli, Cascina (IT)

(21) Appl. No.: 13/128,027

(22) PCT Filed: Nov. 10, 2009
(86) PCT No.: PCT/EP2009/064905

§ 371 Date: May 6, 2011

(30) Foreign Application Priority Data
Nov. 10, 2008 (IT) FI2008A000217

(51) Int. Cl. H01M 12/06

(52) U.S. Cl. 429/406

(57) ABSTRACT

Herein is disclosed a rechargeable zinc-air battery characterised in that the anode consists of essentially spherical copper particles covered by a layer of zinc.

### FIELD OF THE INVENTION

This invention refers to zinc-air battery

### STATE OF THE ART

Zinc-air battery are since long time a research subject since they can be used in many ways, both as small battery for watches, acoustical devices, etc., and as bigger battery suitable for electric vehicles.

In this sort of battery the anode is generally made by zinc while air works as cathode, providing the oxygen that oxidizes the zinc and reduces itself, with a consequent electrons donation; together with the zinc anode, the battery comprises a membrane permeable to OH⁻, that allows the contact between anode and cathode, as above described. The electrolyte is made by an alkaline solution. During the above mentioned reaction the zinc is consumed and when the zinc is completely oxidized (usually to zincate) the battery is substituted (in case of the small battery called “primary”, i.e. disposable) or can be regenerated by mean of an electrochemical procedure that allows the reduction zincate to metallic zinc.

However, during the in-situ recharge of this type of battery zinc dendrites are formed, inhibiting then a homogeneous zinc reduction in the following discharge phase, and limiting thus the efficiency and, mainly, the battery lifetime, limiting the number of charge/discharge cycles available. Furthermore, the formation of dendritic structures is accompanied by a change of electrodes structure, with a change of the occupied volume and of the position compared to a new battery. In a medium and long period this behavior leads to the perforation of the separator that lays between anodic and cathodic compartment and therefore to a short-circuit, rendering the battery completely useless.

In order to overcome to this problem, U.S. Pat. No. 4,517,259 describes batteries in which the anode is constituted by spherical particles having a core that is electrical non-conductive and chemically inert, coated completely or partially by a metallic layer insoluble in the electrolyte (generally Copper or Cadmium). The zinc adheres onto such particle when is in contact with a surface having a more negative potential than that of the zinc deposited in presence of a zincate solution. When the above mentioned solution has more positive potential the zinc layer previously formed dissolves.

The particles slide in the battery dragged by the electrolyte solution moved by a pump.

The U.S. Pat. No. 4,842,963 describes a rechargeable zinc-air battery comprising a zinc electrode constituted by a highly porous metallic foam substrate onto which the zinc is deposited, in order to increase considerably the electrode surface.

Although the advantages offered by the above mentioned solutions in order to overcome the problems associated to the recharge of the battery, these solutions are not yet completely satisfactory and it is therefore evident the necessity of the development of new rechargeable zinc-air battery having better performances.

In fact the U.S. Pat. No. 4,517,259 uses particles having 3 layers, in which the core behaves exclusively as nucleation germ, while the intermediate layer (Copper or Cadmium) promotes zinc deposition. However in this case, together with a more complex system that requires in the first step at least two coating passages, we have a suspension constituted mainly by completely inert material (the inner core), that increases both the suspension mass and the electrical resistance of the system, without any advantage for the cell. This causes both an increased dissipation of the energy necessary for suspension recirculation and a higher electrical current in the recharging phase, without any evident benefit.

Instead in U.S. Pat. No. 4,842,963 the presence of a stationary copper net leads inevitably to dendritic structures formation, sure higher than in a fine powder.

### SUMMARY OF THE INVENTION

It is described a rechargeable zinc-air battery in which the anode is constituted by spherical copper particles, coated by a zinc layer.

### FIGURE DESCRIPTIONS

FIG. 1—schematic representation of anodic compartment of the battery with a possibly associated fuel tank.

FIG. 2—profile of one of the possible geometries for the zinc-air battery, comprising all the constituent components.

FIG. 3—discharge curve for the zinc-air battery described in the invention, containing 3 discharge cycles, alternated with the charge phase.

### DETAILED DESCRIPTION OF THE INVENTION

The present invention allows to overcome to the above mentioned problems, thanks to a rechargeable zinc-air battery as described above, in which the anode comprises essentially spherical copper particles coated by a layer of zinc; the size of these particles is preferably smaller than 500 micron.

Even in the battery according this invention the electrolyte in made by an alkaline solution, usually NaOH or KOH (preferred concentration varies from 20 to 60 wt/vol) that circulate by mean of a pump.

Moreover a battery according to the invention preferably comprises an external tank that allows to have a relatively high reservoir of spare “fuel” and consequently higher autonomy of the battery, permitting to operate with a reduced thickness of the anodic compartment inside the cell. In such way the efficiency of the contact between zinc and ionic-exchange membrane increases.

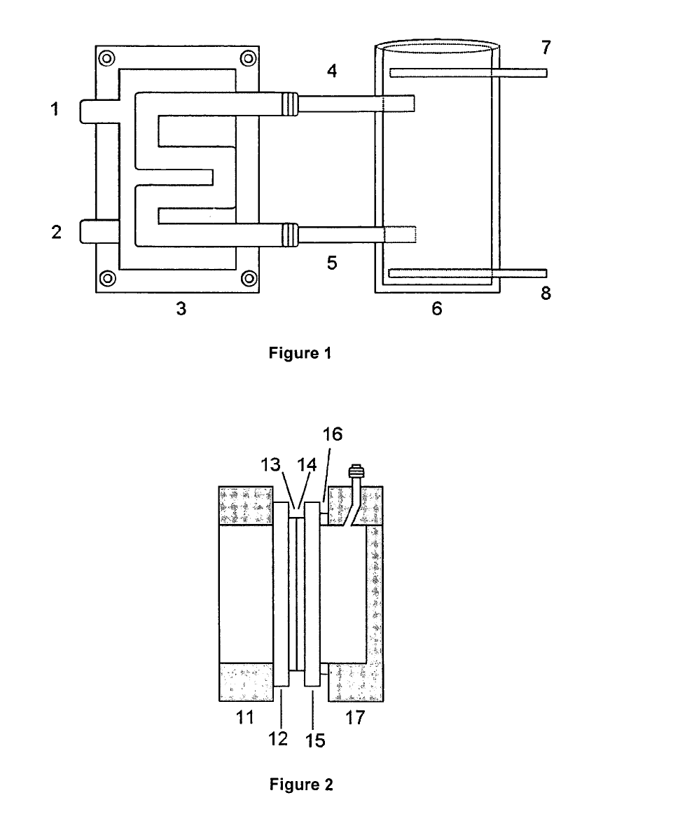

The battery according to the invention essentially comprises (FIG. 2): an anodic compartment 11, that is constituted by a supporting structure, generally made of plastic material, centrally pierced in order to let in the atmospheric oxygen (that is the cathodic fuel), a electricity collector 2, made of a conductive metallic material with a low electric resistance (e.g. stainless steel), a cathode 13, made of a catalyst able to reduce the oxygen and applied to a conductive substrate (e.g. carbon cloth, metallic net, etc.), a polymeric porous separator (e.g. anionic exchange membrane, polymeric film made by zirconia/polysulfone, polymeric films, etc.) 14 and the anodic compartment 17, whose structure is better described in FIG. 1.

Also the anodic compartment is made of a hollow solid supporting structure in which are contained the electrolyte and the copper particles coated by zinc, which acts as anode. The solid structure contains a electricity collector 1 with features similar to those of collector 2 above described, and is associated to a gasket 16 made of an alkaline resistant material (e.g. silicon) for preventing the leakage of the suspension and of the anodic electrolyte.

If preferred (see FIG. 1) the hollowed portion of the anodic support is internally grooved to form a coil 3, in order to generate a path for the suspension that is therefore in contact with all the active surface of the ionic exchange membrane and of the cathode. Thereby being equal the amount of energy required by the recirculation pump is possible to obtain a higher efficiency of the battery and an homogenous discharge of the suspended zinc. The energy produced by the battery is collected by the electricity collectors 1 and 2, respectively next to the anodic and the cathodic compartments.

If preferred to the battery can be connected, by means of pipes 4 and 5, an auxiliary tank 6. which is used both to stock the zinc suspension and as recharge cell for the suspension, once all the covering zinc is converted to zincate, or when the voltage is no more sufficient to run the device connected to the battery. For such purpose a negative electrode 8 (preferably made of a copper foil) and a positive electrode 7, that can be made of Nickel, graphite or a catalyst for oxygen evolution, are respectively placed at the inferior extremity (which is obviously the part of the cell in which the particles decant) and at the superior extremity.

The regeneration step is run keeping the metallic suspension stirred and applying a potential difference between the two electrodes. The zinc is reduced, covering thus again the copper powder. The use of a negative electrode made by a metal that is of the same type of the supporting particles allows, during the following discharge cycle of the battery, to use completely the zinc, even those that is deposited onto the electrode during the regeneration. Obviously, if the tank 6 is lacking, the battery is recharged applying the potential difference directly to the collectors 1 and 2.

The present invention will be more clearly explained according to the following examples:

### Example 1

### Preparation of the Anodic Fuel

1 g of metallic Cu, in the form of 3 micron fine powder, is mechanically dry-stone mixed with 6 g of fine powder of metallic Zn. 5 mL of a 33 wt % KOH solution are added under vigorously stirring, at room temperature, and left stirring for about 5 min. The suspension is then heated under stirring at 70° C. for 10 min, till the copper particles are completely coated by the zinc. The grey suspension obtained is left cooling under stirring.

### Example 2

### Battery Assembly

The suspension prepared according to Example 1 is placed inside an electrochemical cell and circulated at the anodic compartment using a pump, through a coil, passing all the way through an auxiliary external tank. C4014K (Acta SpA) is used as cathode and the anionic exchange membrane A006 (Tokuyama) as polymeric porous separator. The battery works at room temperature and atmospheric pressure.

### Example 3

### Regeneration of the Zinc-Air Battery

The running of the battery causes the progressive consumption of the zinc. As the time pass by, the color of the suspension changes progressively to deep red. When the voltage and/or the current of the battery are lower that the working threshold, the exhaust suspension (containing now uncoated copper powder and a zincate alkaline solution) is completely conveyed to the compartment of the auxiliary tank, which contain at the bottom a negative electrode (preferably copper) and on the top a positive electrode (that can be made of Nickel, graphite or a catalyst for oxygen evolution). The metallic suspension is stirred while the potential difference is applied between the two electrodes. The zinc is reduced thus coating again the copper powder . The duration of the charging process depends on the applied current and on the amount of zinc that must be regenerated. For example, to obtain 6 g of zinc, applying 2 Amp, requires about 2.5 h.

### Example 4

### Running of the Zinc-Air Battery

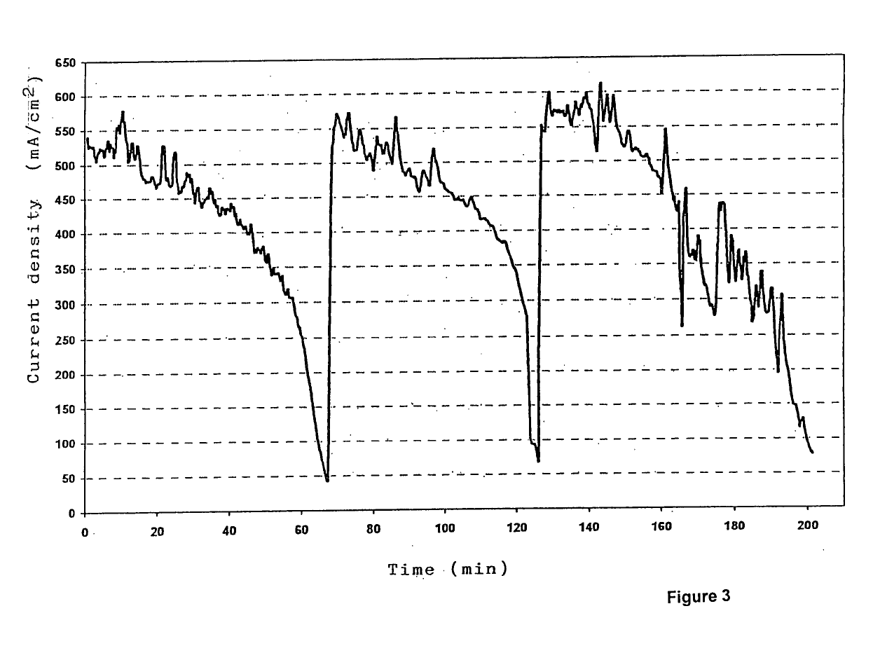

FIG. 3 reports the graph corresponding to the discharge step of the battery described in this invention. Such test had been performed using a suspension prepared according to the example 1, containing 1 g of copper as support and 2.2 g of zinc. The battery discharge had been obtained working with a constant voltage of 900 mV. The charge had been carried on applying 3.5 Amp for 6 min. It is evident that after each recharging step the corresponding discharging curves are completely reproducible, demonstrating that a successfully rechargeable zinc-air battery is obtained.

1. A rechargeable zinc-air battery characterised in that the anode consists of essentially spherical copper particles covered by a layer of zinc.

2. The battery according to claim 1 wherein said particles have a dimension inferior to 500 microns.

3. The battery according to claim 1 comprising, in sequence: a cathode compartment (11), presenting a central hole to allow the passage of the atmospheric oxygen, which is the cathode fuel, an electricity collector (2), a cathode (13), a polymeric porous separator, an electricity collector (1), a seal (16) made of material resistant to alkali attack and an anode compartment. (17).

4. The battery according to claim 3 wherein said electricity collector (2) is made of a conductive metal having low electric resistance.

5. The battery according to claim 3 wherein said cathode (13) is a catalyst capable of reducing oxygen applied on a conductive support.

6. The battery according to claim 2 wherein said anode compartment comprises a support frame presenting in its interior a series of grooves forming a serpentine (3) forming an obliged path for a suspension comprising of said particles and the electrolyte.

7. The battery according to claim 6 wherein the electrolyte is an alkaline solution circulating in the anode compartment under the action of a pump.

8. The battery according to claim 1 comprising an auxiliary external tank (6) connected to the anode compartment by tubes (4) and (5) capable of operating as recharge cell once all the zinc covering the particles is transformed into zincate or when the voltage is no longer sufficient to run the device connected to the battery, comprising at its inferior and superior extremities respectively a negative electrode (8) and a positive electrode (7) to which the necessary difference of potential difference is applied during the recharge of the battery.

9. The battery according to claim 1 for use on motor vehicles.
